(19) United States
(12) Patent Application Publication
(10) Pub. No.: US 2003/0042475 A1
(43) Pub. Date: Mar. 6, 2003

(54) Bracing apparatus and method of use

(76) Inventor: Phillip Eugene Passafuma, Pineburst, TX (US)

Correspondence Address: THE MATTHEWS FIRM, 1900 WEST LOOP SOUTH, SUITE 1800, HOUSTON, TX, 77027-3224, US

(21) Appl. No.: 10/230,467

(22) Filed: Aug. 29, 2002

Related U.S. Application Data
(60) Provisional application No. 60/316,172, filed on Aug. 30, 2001.

(51) Int. Cl. A45F 3/44; F16M 11/24

(52) U.S. Cl. 256/35; 248/156; 248/165

(57) ABSTRACT

An improved brace preferably for use with a post or other vertical or substantially vertical member. The brace is generally constructed of a first and second member which are connected, with the opposite or free end of each member being connected to, joined with, attached to, or retaining at least a portion of the post or other substantially vertical structure or member. The brace can be used without penetrating the substrate and is adjustable to different angles, heights, and forces.

### RELATED APPLICATIONS

This application claims priority from U.S. Provisional Application No. 60/316,172 filed Aug. 30, 2001.

### TECHNICAL FIELD

The present invention relates to apparatuses and related methods of use for bracing a post or other substantially vertical member.

### BACKGROUND ART

For purposes of this patent, the following terms are defined. As used herein, the term T-post means and refers to a post in the form of a T, as disclosed in U.S. Pat. No. 5,042,780 to Yearwood (the '780 patent); U.S. Pat. No. 5,356,101 to Malloy (the '101 patent); U.S. Pat. No. 5,460,344 to Malloy (the '344 patent); U.S. Pat. No. 4,889,322 to Wagner (the '322 patent); U.S. Pat. No. 5,061,109 to Miller (the '109 patent); and the like. As used herein, the term livestock means and refers to any animal that is capable of being fenced whether domesticated or wild.

As disclosed in the '780 patent, T-posts and wire fences are frequently used for electric fences and temporary fences. As well, T-posts have gained popularity for permanent fences for several reasons, including the cost of more traditional wooden posts and the relative ease of erecting a T-post fence as compared to a wooden fence.

As the '101 patent discloses, rural fence posts for hanging barbed wire and/or twisted wire, are typically driven into the ground with sledgehammers or drivers. Various other methods include digging holes for the posts and then inserting the posts in the hole.

One commonality that is present in all types of fencing is the necessity to brace corner posts. Such bracing is necessary for a variety of reasons, including to allow the wire hung to be drawn taut and to provide extra strength for the fence. Common prior art methods of bracing corner posts include, as disclosed in the '101 patent, pouring concrete into a hole and using a wooden fence post. This prior art method, when performed correctly, provides a strong and braced corner post. However, it typically takes an hour or longer to set a corner post in this manner. Accordingly, the prior art has sought an apparatus and method for setting corner posts more quickly. As well, the prior art has sought apparatuses and related methods for setting a T-post as corner post.

A prior art solution to this problem can be found in the '780 patent. The '780 patent discloses a metallic brace that is composed of two elongated members that are fixedly connected at a first end. The two members generally extend from the first end such that the first and second member form a V-shaped brace. The second end of each member is a soil penetrating member with a transverse bar. The first end further comprises a hingedly mounted angular bracket that surrounds and grips a portion of a T-post, lodged against at least one of the protrusions on a T-post. In use, the second ends of the brace disclosed by the '780 patent are driven into the ground to about the transverse member. This prior art solution is very effective, however, some substrates, such as rocky soils, are very difficult to penetrate and often large amounts of time and/or effort is required in sinking members into the soil. Accordingly, the art field is in search of a method of bracing a T-post that does not require additional soil penetration beyond that for the T-post.

Another related prior art method is disclosed in the '181 patent. This patent discloses a bracing system for a corner post. The end or corner post has a main upright post, supported by a main brace. The main post has a deadman post attached near its lower end below ground. The main brace has a bearing plate rigidly and perpendicularly attached below ground level. A cross brace is provided that has an end fixedly attached to the main brace and an end fixedly attached to the main post. While this patent does disclose a device that provides a bracing system for a corner post, it requires penetration of the substrate by multiple members. Accordingly, the art field is in search of a method of bracing a T-post that does not require additional soil penetration beyond that for the T-post.

Other prior art solutions are disclosed in related the '101 and the '344 related patents. These patents disclose a brace system that has an elongated bearing element that is received in the bite (protrusions) of the T-post and a collar member that fits over the top of a T-post. The brace has at its bottom end a stake holder which receive a stake that is driven into the ground. As the '101 patent states, the first feature of the fence support is a main support that is adapted to be driven into the ground and the second feature is a stake holder. The '344 patent recites like limitations and elements. Both the '101 and the '344 patent disclose another beneficial feature that the brace may be used with an existing fence line and/or T-post. However, a bracing system is not disclosed that does not require penetration of the soil. Accordingly, the art field is in search of a method of bracing a T-post that does not require additional soil penetration beyond that for the T-post.

Another prior art solution is found in the '322 patent. This patent discloses a system wherein slidable collars are positioned over a corner T-post and adjacent T-posts in a wedging arrangement. The '322 patent further discloses accessories to allow the wedged bracing system for use with a gate frame, straight fence support and/or the like. While this patent does not require soil penetration, the patent does require the use of adjacent T-posts for support. Accordingly, the art field is in search of a method of bracing a T-post that does not require additional soil penetration beyond that for the T-post and is not braced off an adjacent T-post.

Other apparatuses and methods for providing a brace for a T-post are found in the '109 patent and U.S. Pat. No. 4,682,761 to Henneken, however, these patents do not disclose a bracing system for a T-post that do not require bracing from adjacent T-posts and/or other posts.

As has been previously discussed above, one use of T-posts is for an electric fence. In general the T-posts have a clip for connecting the electric fence to the T-posts. The clips of the prior art generally cooperate with at least one protrusion of a T-post and partially surround the T-post to form an interference fit. However, the prior art braces have not included a provision for the securing of a hot wire to the braced T-post. A brace that provided an accessory for securing an electric wire, commonly called a ‘hot wire,’ would be beneficial. Prior art clips include those as disclosed in U.S. Pat. Nos. 3,820,758 to Burg and 4,077,611 to Wilson. Unfortunately, these clips often prevent any device from movement along the T-post because the clips tend to extend away from the T-posts and commonly already have ‘hot wire’ attached. Accordingly, the art field has searched for apparatuses and related method of use whereby a post, and/or T-post, may be braced that already has a ‘hot wire’ hung. As well, a simply connected accessory for securing a wire would be beneficial.

Another prior art problem and a problem that the art field will continue to face is the shrinkage of available land upon which to raise animals. Prior art ranches and farmlands allowed the animals to be rotated through the entire ranchland with maybe a portion or two separated for growing seasonal grasses for the animals. The growth of the human population has shrunk the available land upon which to raise animals, thereby creating a need for new systems for rasing animals and/or livestock. One approach is the rotation of animals from a small portion of a farm to another small portion of a farm. In this manner, as the livestock are kept in area of the ranch, the grasses and other foods are allowed to recuperate on the other unused portion of the land. After a period of time, usually when the livestock have eaten a portion of the available food supply, the livestock may be rotated to a portion of the land that was unused before, thereby allowing the previously used lands to recuperate while the livestock eat on another portion. The creation of the portions of land requires a tremendous amount of time and labor in fencing the sections. The ability to more quickly erect new fences or new portions for the ranch would be a benefit as to labor and supply costs. As well, the ability to construct a fence and corner posts system that could be easily removed and erected elsewhere would be a benefit.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1a is an illustration of an embodiment of an apparatus of the present invention.

FIG. 1b is a component of an embodiment of the present invention.

FIG. 1c is a component of an embodiment of the present invention.

FIG. 1d is an illustration of an embodiment of a member of the present invention.

FIG. 2 is an illustration of an embodiment of a brace of the present invention with second and third members in use with line.

FIG. 2a is a close-up of the hingedly attached members.

FIG. 3 is an illustration of two braces in use at a corner.

FIG. 3a is a cross-sectioned view of a T-post.

FIG. 3b is an alternative latch and latch attachment.

FIG. 3c is an alternative latch and post in use.

FIG. 4 is an illustration of an alternate use of embodiments of the present invention.

FIG. 5 is an illustration of two braces in use at a pull point.

FIG. 6 is an illustration of multiple braces in use.

### GENERAL DESCRIPTION AND PREFERRED MODE FOR CARRYING OUT THE INVENTION

For purposes of the description of this invention, the terms “upper,” “lower,” “right,” “left,” “vertical,” “horizontal,” “top,” “bottom,” and other related terms shall be defined as to relation of embodiments of the present invention as it is shown and illustrated in the accompanying figures. However, it is to be understood that the invention may assume various alternative structures and processes and still be within the scope and meaning of this disclosure. Further, it is to be understood that any specific dimensions and/or physical characteristics related to the embodiments disclosed herein are capable of modification and alteration while still remaining within the scope of the present invention and are, therefore, not intended to be limiting.

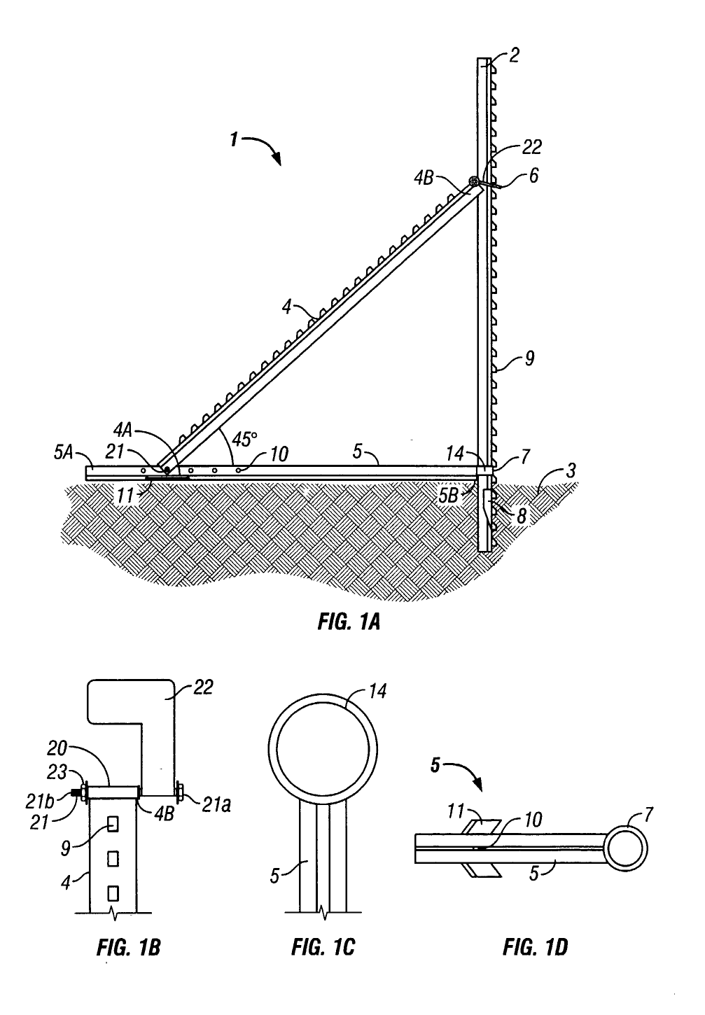

Referring now to FIG. 1a, an illustration of an embodiment of the present invention, the cooperation of a system and apparatus 1 of the present invention and a post is illustrated. The brace can also be used with other vertical or substantially vertical members for a variety of applications. Various embodiments of the present invention can be constructed of common and ordinary parts and components. For example, first member 5 and second member 4 and/or third bracing member 15 can be constructed from posts or other members which are prefabricated such as T-posts, and maybe alternatively specially manufactured.

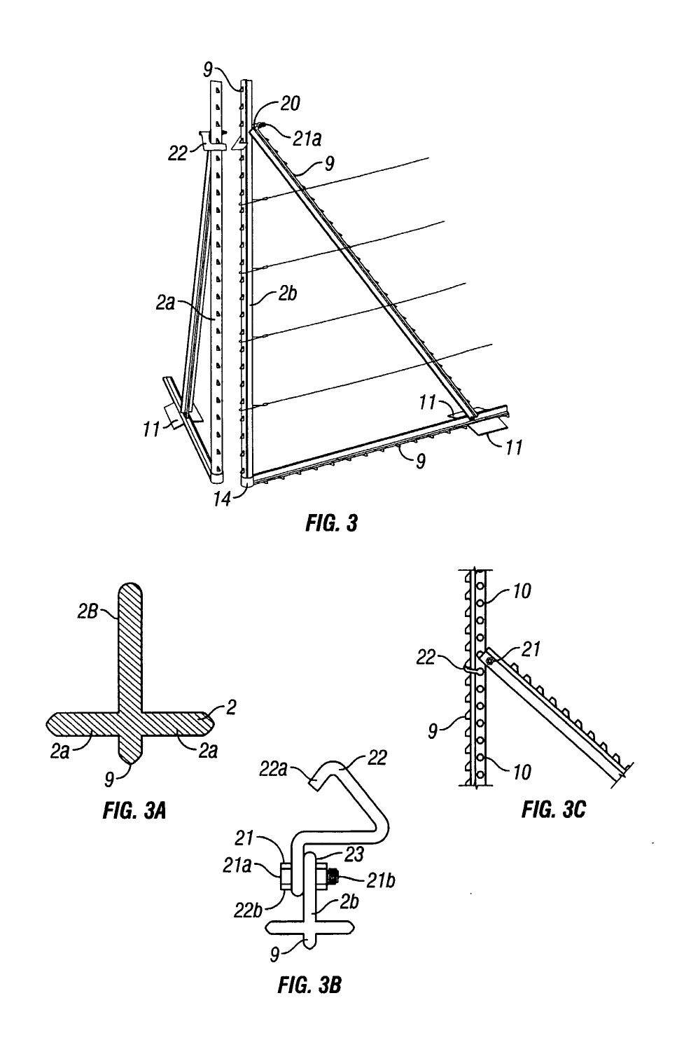

A T-post 2 is preferably used in conjunction with the bracing invention, but is not necessary. Generally, a T-post 2 is a metallic elongated member with anchor portion 8 having a front face leg 2a and a perpendicular rear leg 2b centered within the front leg which is joined together to form a “T” configuration. See, e.g., FIGS. 3, 3a. T-posts are commonly adapted to be driven into the ground to support a wire fence and/or to support or brace a variety of vertical or substantially vertical structures, items, and things, also including plants, trees, clothes line, tent posts, and the like.

Various embodiments of the present invention are adapted to be used for bracing or tightening an existing fence line while other embodiments are adapted for use in a fence line that is being constructed. The T-post 2 or other vertical member and/or the bracing members may also have at least one lug 9 extending from at least one side. T-posts are commonly used in a variety of applications in which a vertical post is desired or needed. If fences are being constructed, a T-post is the preferred vertical member since it has a plurality of lugs which can be used to hold the latch or fastener of the second member or other upright member or angled member into place. The lugs may also be used to space or hold the lines or wire in their preferred position. If there are lugs on the downwardly surface of the first member, they may also act to grip the substrate. Other embodiments of T-posts 2 or bracing members may have multiple lugs 9 extending from multiple sides. See, e.g., FIGS. 1, 3. The T-post may also have a plate or anchor 8 which holds the post in place when it is driven into the ground or other substrate. The post or vertical member to be braced may be temporarily placed within the substrate such as soil, and may also be permanently installed in the substrate such as with cement. Also, the substrate may be comprised of a variety and combination of materials such as gravel, asphalt, concrete, rubber, and a multitude of other materials in the art.

In FIG. 1a, post 2 is driven into the substrate 3. In other embodiments, at least a portion of the anchor 8 of the post is driven into the substrate 3 by manners common in the art, such as by hammering. Generally, the brace or bracing system 1 is comprised of a first member 5 or base with a first end 5A and a second end 5B and a first connection 7 to or with a post 2 or other vertical or substantially vertical member, a second member 4 with a first end 4A and a second end 4B and a second connection 6 to or with a post 2 or other vertical or substantially vertical member. In the preferred embodiment, the bases or first members are of 3, 6, 9, and 12 foot lengths, although they can be of various lengths. Typically, the first member is horizontal or substantially horizontal during use and may also rest or substantially rest along or against a substrate. Also, the second and third members may be of varying lengths, but are typically longer than the first members and when angled will be located below the top end of the post or other vertical member. A portion of the first member 5 and the first end 4A of second member 4 are also hingedly connected, preferably by a bolt which is inserted into an aperture or hole within one face of each member. The first member 5 and second member 4 can be bolted in fixed arrangement or in a hinged arrangement. Preferably the bolt is tightened so that there is friction between the first and second members, which will hold the first and second member in the desired angle during installation. Other embodiments may use alternative means of connection such as rebar, cotter pin, snap cap, pin wire, a hook, a latch, an end cap, a hinge and/or the like.

Preferably there is also a foot 11 located beneath the bottom side of the first member or which alternatively extends outward from the first member near the location or area where the first and second members are hingedly attached. This keeps the horizontal member from penetrating the substrate as force as exerted downwardly from the angled second and/or third members.

The first connection 7 is preferably attached at or near a second end 5B of first member 5, but can also be located along other areas of the first member. In an embodiment, connection 7 is rigidly attached to the second end 5B of first member 5. During use the angle between the first member and second member may vary between about 35 to 55 degrees, but is preferably about 45 degrees, whereas the angle between the first member and said post may vary between 35 to 55 degrees, but is preferably about 90 degrees during use. Additionally, during use the angle between the second member and said post may vary, but is preferably about 45 degrees.

Connection 7 is generally in contact and circumferentially engages or may alternatively partially surround the post 2. In an embodiment, connection 7 is accomplished by a circular retainer 14 with a diameter large enough to slip down around the post or other vertical member. In another embodiment, the connection 7 is accomplished by a retaining means which is configured and/or shaped to engage the T-shape of post 2 such that retaining means 14 can be reasonably secured or connected to a post with fence lines already in use or another vertical member of varying diameters already in the substrate such as by a loop of any shape which can be opened, like that of a notebook ring or a loop or other member which can be swivelled to retain, hold, attach to, or surround the post near the substrate so the brace will not move away from the post of other vertical member or item being braced. The retainer 14 may be of any shape and may be rigid or even flexible such as a wire loop (not shown). However, other embodiments of connection 7 and retaining means 14 will be readily apparent to those of ordinary skill in the art and only require that connection 7 at least partially surrounds a portion of the vertical member or post 2.

Connection 6 the second connection, is the junction between the second member and the post. This can be accomplished by a variety of means such as rebar, wire, a hook, a latch, a bracket, a pin, a C-clamp, an anchor, and the like known to one of ordinary skill in the art, which is preferably located at or near the second end 4B of second member 4. In an embodiment, the fastener is hingedly connected to second member 6. In another embodiment, the fastener is fixedly connected to second member 4. While the connection between the second member and the post may be removably or securably attached, connection 6 is generally any connection that cooperatively engages a portion of the post, post hole 10, or at least one lug of post 2. Again in the preferred embodiment, connection 6 is accomplished by a fastener comprised of a L-shaped bracket that is hingedly connected to vertical post 2 and during use extends around a portion of vertical post 2 and engages a lug of post 2. See, e.g., FIGS. 1A, 2, 3.

Now referring to FIG. 1B, an illustration of a L-shaped bracket is disclosed which facilitates the second connection 6. A variety of other means may be used to facilitate the second connection. In this embodiment, the second end 4B of the second member 4 is modified so as to form an attachment between the bracket and the bracing member, and a metal sleeve 23 is welded onto the second end of the second bracing member. The L-shaped bracket 22 is also welded to the bolt near the head end 21a of the bolt 21, and the bolt and the joined bracket is inserted into the sleeve, which is of a larger diameter than the bolt, and a nut 23 is screwed onto threaded end 21b of the bolt. This arrangement allows swiveling and rotation of the bracket and the bracket is rotated over the top of the post and fastened thereto. In the depicted embodiment, the bracket 22 fits around the post and fastens between adjacent lugs 9 of the post 2. In alternate embodiments, the bracket may swivel around the post or may alternatively be fixedly connected to second end of second member 4 (not shown). Other bracket or fastener shapes could be used such as an “H,” “U,” “V,” and “C,” or substantially shaped and any other configuration which will allow the bracket to be fastened to the post, such by, at, or near a lug.

Now referring to FIG. 3B, an illustration of an alternate fastener is shown which can also facilitate the second connection 6. Again, a variety of other means may be used to facilitate the second connection. In this embodiment, rather than attaching the fastener through a sleeve which is attached to the second member 4, an aperture is made through the perpendicular rear leg 2b of the second member which here in this embodiment is made from a T-post and the fastener is bolted directly to the post. See FIG. 3B. Preferably, the aperture is made near the second end 4B of the second member. This attachment is facilitated by a hole 22b in the fastener 22 and a bolt 21 with a head 21a and a threaded end 21b is inserted through the hole in the fastener and is then secured to the second member by a nut 23. Similar to the embodiment of FIG. 1, the fastener can be swivelled and rotation over the end of the post and can fasten and lock beneath the lugs 9 of the post 2. In a further alternate embodiment, the post may have a series of holes located along its axis, and the fastener may have a modified end, e.g., 22a, which fits into the desired hole. See, e.g., FIG. 3c. Again the fastener may be of a variety of shapes such as an “H,” “U,” “V,” and “C,” and variations thereof, or any other configuration which will allow the bracket to be fastened to the post.

Now referring to FIG. 1C, an embodiment of a retainer 14 on the second end of the first member 5 which facilitates the first connection is illustrated. The retainer 14 as shown is circular, but can be of various shapes and configurations and may also be partially open and/or capable of being closed around the item which is being braced. The retainer should preferably also be of a large enough diameter to fit around the post, vertical member or item to be braced.

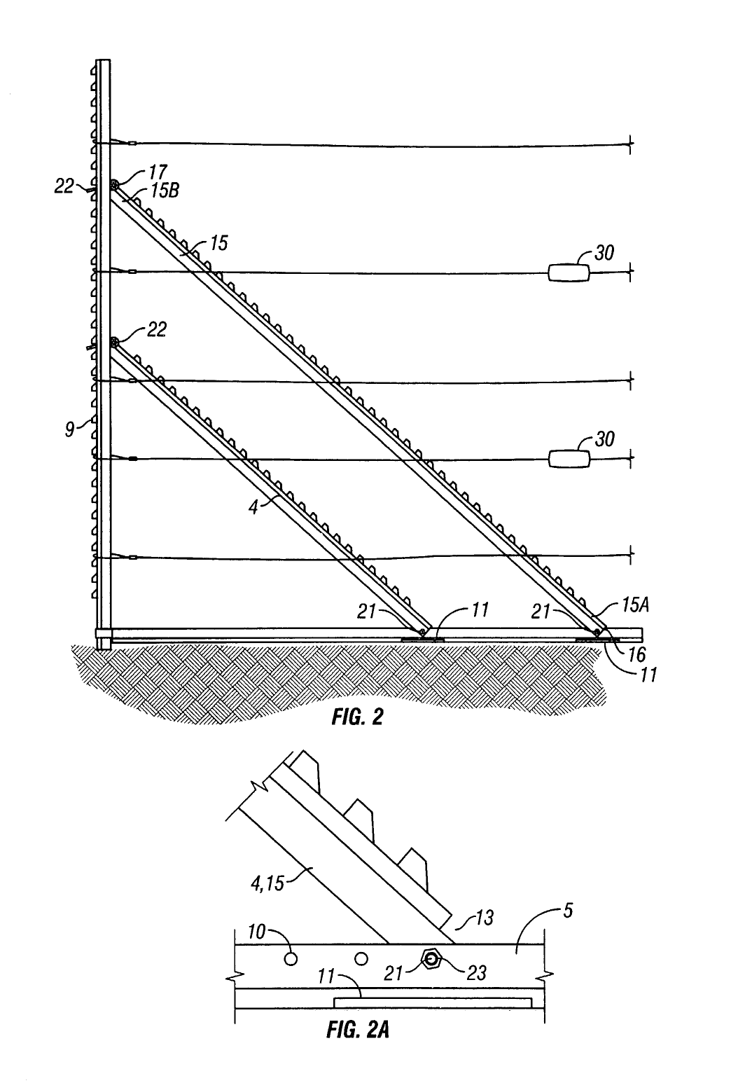

Now referring to FIG. 1D, an illustration of first member 5, an embodiment of construction is illustrated. First member 5 is generally an elongated member having a retainer 14 near or at the second end 5B and a portion at or near for connection of second member 4. If a T-post is used for the second member a portion preferably about 1 inch of one side of the front face leg 2a, i.e., a side 13 of the face on one side of the lug from the second 4 or third member 15 is removed. See FIGS. 2, 2a. Again, there may be a foot 11 or other similar plate-like structure located below the area or extending from the adjacent side areas where the first and second members are hingedly attached.

System 1 is engaged with post 2 by engaging connection 7 with a portion of post 2 such that first member 5 lays substantially along substrate 3. Second member 4 hingedly extends from first member 5 such that connection 6 can be engaged with an upper portion of post 2. After installation, the braces are also fully adjustable to keep the wires or lines taut and to keep the force upon the post. This force keeps the post upright and prevents the post from becoming loosened or pulled out from the substrate. To adjust the angle and force of the brace, the fastener is unlatched or unfastened. Then, the angle of the brace is changed to the desired position and the fastener is again fastened or latched to the post lug 9, hole 10 or other such means which removably attach and secures the member to the post. In use, the brace or bracing system 1 braces post 2 for constructing fences or wire, electrified or not, line, wire hanging, fence hanging, gate hanging and the like.

When constructing a fence line and/or pastures for grazing, such as a new pasture or new fence line, corners are required. The present brace is typically used on an inside corner of a fence being constructed, i.e., directed toward the post. When a corner is required, installing embodiments of the present invention allows wire to be drawn taut. In various embodiments, an embodiment of the present invention is only used on one inside portion of a corner. In other embodiments, both inside portions of the corner are used for bracing. See, e.g., FIG. 3.

Additional embodiments may have more than one bracing member which extends upwardly from the first bracing member. For example, FIG. 2 has a plurality of bracing members such as a second and third bracing member which removably or securably attach to the first bracing member. Similar to the first member 5 and second member 4, the third member may be constructed from a T-post, but does not have to be. The third member 15 similarly has a first end 15A and a second end 15B. A third connection 16 is formed by a junction between the third member and the base or first member. This can be accomplished by a variety of means such as rebar, wire, a hook, a latch, a bracket, a pin, a C-clamp, an anchor, a cotter or spring pin, and the like known to one of ordinary skill in the art, which is preferably located at or near the first end 15A of the third member 15. In this embodiment, the third member 15 is hingedly connected to first member 5 by a bolt 21, which is inserted into an aperture or hole within one portion or face of each member. Preferably the bolt is tightened so that there is friction between the first and third members. Other embodiments may use a separate connection portion such as rebar, wire, a hook, a latch, an end cap, a hinge and/or the like. There is also a fourth connection in this embodiment 17 which is preferably at or near a second end 15B of the third member 15 but can also be located along other areas of the third member, with the post 2 or other vertical or substantially vertical member. During use the angle between the first or base member and third member may vary, but is preferably about 35 to 55, but is preferably about 45 degrees during use.

A variety of other means may be used to facilitate the fourth connection. In an embodiment the second end 15B of the second member 15 is modified so as to form an attachment between the bracket and the bracing member and a metal sleeve 23 is welded onto the second end of the third bracing member and a L-shaped bracket 22 is welded to the bolt near the head end 21a of the bolt 21. After the bolt is inserted into the sleeve, a nut 23 is then screwed onto threaded end 21b of the bolt to secure the fastener to the member. See, e.g., FIG. 1B. This arrangement allows swiveling and rotation of the bracket and the bracket is rotated over the top of the post and fastened thereto. In the depicted embodiment, the bracket 22 fits around and fastens between adjacent lugs 9 of the post 2. In alternate embodiments, the bracket may swivel around the post or may alternatively be fixedly connected to second end of third member 15. Other bracket or fastener shapes could be used such as an “H,” “U,” “V,” and “C,” and any other configuration which will allow the bracket to be fastened to the post, such by, at, or near a lug.

Now referring to FIG. 3B, an illustration of an alternate fastener is shown which can also facilitate the fourth connection 17. Again, a variety of other means may be used to facilitate the fourth connection. In this embodiment, rather than attaching the fastener through a sleeve which is attached to the third member 15, an aperture is made through the perpendicular rear leg of the third member which can be made from a T-post and the fastener is bolted directly to the third member. See FIG. 3B. Preferably, the aperture is made near the second end 15B of the third member. This attachment is facilitated by a hole 22b in the fastener 22 which is near the attachment end of the fastener and a bolt 21 with a head 21a and a threaded end 21b is inserted through the hole in the fastener and is then secured to the third member by a nut 23. Similar to the embodiment of FIG. 1, the fastener can be swivelled and rotated over the end of the post and can fasten and lock beneath the lugs 9 of the vertical post 2. In a further alternate embodiments, the vertical or other vertical member post may have a series of holes located along its axis, and the fastener may have a modified end, e.g., 22a, which fits into the desired hole. See, e.g., FIG. 3c. Again the fastener may be of a variety of shapes such as an “H,” “U,” “V,” and “C,” and variations thereof, or any other configuration which will allow the bracket to be fastened to the post.

Various embodiments of the present invention can be permanently left on the corner post while various other embodiments may be removed after drawing a wire taut, or after removing the corner post or fencing installation. Other embodiments of the present invention are configured to be extendible to any desired height, such as high fences for exotic game. Further embodiments may have an insulated wire holder 30 which enables the use of electrified wire to keep animals away from the fencing. See e.g., FIG. 2.

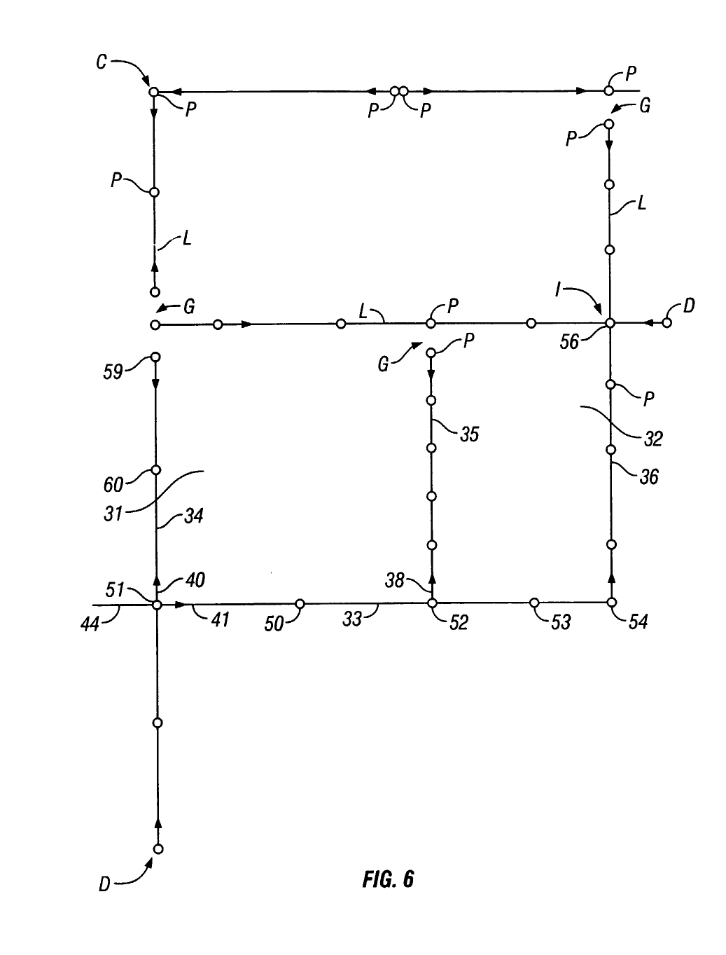

Now referring to FIG. 6, an aerial or overhead illustration of various uses of the invention. FIG. 6 shows multiple pastures and fence lines e.g., 33, 34, 35, 36, 44 erected with embodiments of the present invention e.g., 38, 40, 41, 59. While the braces are in alignment with the fence line or wire when used, the arrows indicate the use of the brace of this invention and show the direction in which the brace is installed. In other words, the retainer of the first member is placed around the post e.g., 50, 51, 52, 54, 56, 60, or Pand the first end is positioned away from the post in the direction of the actual or desired fence line. As can be seen, there are various uses of the present invention. Generally, a pasture 31 and 32 are constructed from a fence line 33. When a new pasture is desired, such as when rotating grazing land, two circumstances arise, either of which embodiments of the present invention may be used. In one situation, no fence exists or the posts remain and the fence line has been temporarily removed. In such a situation, posts are installed and a wire strung between the adjacent posts. To tighten or draw taut the wire between posts, embodiments of the present invention may be installed and the wire drawn tight such as in a pull point PP shown in FIGS. 5-6. The present invention will reduce the work required in laying fence by about fifty percent or more. As well, the time and cost required to lay the fence will be greatly reduced. Pasture 31 uses an embodiment of the present invention and in each inside corner C of the fence line. Pasture 32 uses only one embodiment of the present invention 38 in the inside corner C of the fence line 33, 35, and 36. The embodiments can also be used in the dead ends D of the fence lines. In a like fashion, if fence line 34 and fence line 44 existed and extending fence line 44 into fence line 33 was desired, embodiment e.g., 41 can be used to provide support.

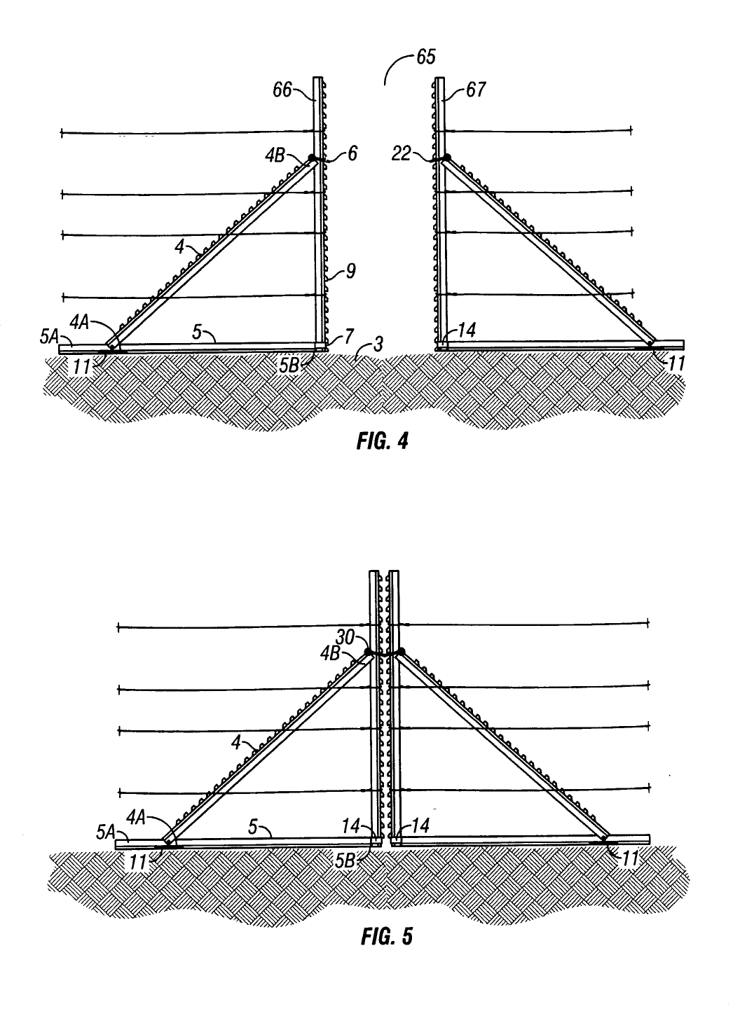

Now referring to FIGS. 4, 6, an illustration of additional uses of embodiments of the present invention, support for a gate G or passage is illustrated. It is common in the art for a gate or passage 65 to be interposed between two adjacent posts P. In this embodiment, posts 66 and 67 allow passage and are not connected by wires. Embodiments of the present invention may be employed substantially along the fence line L from each of post 66 and post 67 to provide the necessary support, where a gate G or passage is employed.

While preferred embodiments of the present invention have been disclosed, it will be readily apparent to those of ordinary skill in the art that many modifications may be made and for a further understanding of the nature and scope of the present invention, attention should be had to the appended claims.

I claim:

1. A brace for use with a post, said brace comprising:
a first member having a first end and a second end and a retaining member near or at said second end, said retaining member adapted for retaining a lower portion of a post;
a second member having a first end and a second end, wherein a portion of the first end of the second member and a portion of the first member are connected, and wherein said second end of said second member is adapted for engagement of a portion of a post.

2. The brace of claim 1, wherein during use the first member substantially rests along or against a substrate.

3. The brace of claim 2, further comprising a foot beneath the connection between the first and second members, wherein said foot rests on a substrate during use.

4. The brace of claim 1 wherein the second end of the second member is hingedly connected to first said member.

5. The brace of claim 1, wherein during use the angle between the first member and second member is about 35 to 55 degrees, and wherein during use the angle between the second member and said post is about 35 to 55 degrees.

6. The brace of claim 1, wherein during use the angle between the first member and said post is about 90 degrees.

7. The brace of claim 1 having a latch or fastener attached at or near said second end of second said member, and wherein during use said latch or fastener is removably attached to said post.

8. The brace of claim 1, wherein said fastener comprises a L-shaped bracket, a C-shaped bracket, a U-shaped bracket, a H-shaped bracket, or a V-shaped bracket.

9. The brace of claim 7, used with a post having a plurality of lugs integral with and extending from at least one side of said post, wherein said latch or fastener is placed between said lugs and pushed up against an upper lug to a locked position.

10. The brace of claim 7, used with a post having a plurality of holes along its axis of said post, wherein said latch or fastener is placed within at least one hole.

11. The brace of claim 1, wherein at least one said member comprises a T-post.

12. The brace of claim 1, having a third member with a first end and a second end, wherein a portion of the first end of the third member and a portion of the first member are hingedly connected, and wherein said second end of said third member is adapted for engagement of a portion of a post.

13. The brace of claim 11, having a latch or fastener attached at or near said second end of third said member, and wherein during use said latch or fastener is removably attached to said post.

14. A system for bracing a vertical member comprising:
providing a first member with a first end, a second end, and a retaining member near or at said second end of said first member;
providing a second member with a first end, a second end and a fastening member near or at the second end of the second member;
connecting the first to end of the second member to a portion of the first member to form a brace;
providing or locating a substantially vertical member anchored to substrate
providing a first connection between the retaining member and the vertical member; and
providing a second connection between the fastening member and the vertical member.

15. The system of claim 14, wherein at least one of said bracing members or said vertical member has a plurality of lugs integral with and extending from at least one side of said bracing member.

16. The system of claim 14, wherein said vertical member has a plurality of holes along its axis and said second member is removably attached to at least said hole.

17. The system of claim 14, further comprising at least one line or wire integral with or attached to said vertical member.

18. The system of claim 17, wherein during use the brace is aligned with said line or wire.

19. The system of claim 14, wherein during use the brace is positioned on the inside of a corner.

20. The system of claim 14, further comprising at least one brace in each corner.

21. A method of making temporary or permanent fencing comprising the steps of:
providing or locating a substantially vertical member grounded in substrate;
providing a first member with a retaining member which substantially rests along or upon the substrate;
providing a second member with a fastening member;
attaching a portion of said second member to said first member;
placing the retaining member around a lower portion of said vertical member;
adjusting the attached second member to the desired angle;
removably or securably fastening said second member to an upper portion of said vertical member; and
attaching at least one wire or line to said vertical member.

22. The method of claim 21, further comprising the step of placing a foot beneath the connection between the first and second members, wherein said foot rests on a substrate during use.

23. The method of claim 21, wherein said vertical member has a plurality of lugs integral with and extending from at least one side of said vertical member.

24. The method of claim 21, further comprising the step of locking said fastener beneath at least one said lug or between said lugs.

25. The method of claim 21, wherein said vertical member has a plurality of holes therein and wherein said fastener is placed into at least one said hole.

26. The method of claim 21, further comprising the steps of:
adding an insulated wire connector to said line or wire;
connecting wire to said connector; and
electrifying said wire.

27. The method of claim 21, further comprising the step of removing said brace from said vertical member.

28. The method of claim 21, further comprising the steps of:
unfastening said second member;
adjusting the tension of the line or wire by adjusting the angle between said first and second member; and
fastening said second member to said vertical member.

29. The method of claim 21, further comprising the steps of:
adjusting the tension of the line or wire by adjusting the angle between said first and second member and fastening said second member to said vertical member;
twisting or tying the line or wire to remove any surplusage wire or line; and
removing said brace from said vertical member.

30. The method of claim 21, wherein said vertical member and/or at least one of said bracing members comprises a T-post.

31. The method of claim 21, wherein said second member is hingedly attached to said first member.

32. The method of claim 21, further comprising the steps of:
providing at least one additional member with a fastening member;
hingedly attaching a portion of said at least one additional member to said first member;
adjusting the hingedly attached member to the desired angle; and
removably or securably fastening said member to an upper portion of said vertical member.

33. A brace for use with a substantially vertical member, said brace comprising:
a first member having a first end and a second end;
means for retaining a portion of said substantially vertical member near or at said second end of said first member;
a second member having a first end and a second end;
means for connecting said first and second members; and
means for removably or securably attaching a portion of said second member to said vertical member.

34. The brace of claim 33, wherein during use the first member substantially rests along or against a substrate.

35. The brace of claim 34, further comprising a means for preventing the first member from penetrating the substrate.

36. The brace of claim 33, wherein the said first and second members are hingedly connected and/or frictionally engaged.

37. The brace of claim 33, having a plurality of lugs integral with and extending from at least one side of said bracing member.

38. The brace of claim 33, used with a vertical member which comprises a T-post.

39. The brace of claim 33, having a third member with a first end and a second end, wherein a portion of the first end of the third member and a portion of the first member are hingedly connected, and wherein said second end of said third member is adapted for removable or secured attachment of a portion of substantially vertical member.
